(19) United States
(12) Patent Application Publication
(10) Pub. No.: US 2026/0257639 A1
(43) Pub. Date: Sep. 3, 2026

(54) DRIVER POSITION MONITORING SYSTEM

(71) Applicant: GM Global Technology Operations LLC, Detroit, MI (US)

(72) Inventors: Craig Thomas Douglas, Pflugerville, TX (US); Michael Babb, Seattle, WA (US); Vincent Engeln, Fort Collins, CO (US); Russell A. Patenaude, Macomb Township, MI (US)

(73) Assignee: GM Global Technology Operations LLC, Detroit, MI (US)

(21) Appl. No.: 19/066,619

(22) Filed: Feb. 28, 2025

(51) Int. Cl. B60R 16/037; B60N 2/00; B60N 2/02; B60N 2/66; B62D 1/18; G07C 5/00

(52) U.S. Cl. CPC B60R 16/037; B60N 2/0027; B60N 2/0273; B60N 2/66; B62D 1/18; B60N 2/0226; G07C 5/008

(57) ABSTRACT

A computer-implemented method when executed by data processing hardware causes the data processing hardware to perform operations. The operations include identifying, via a driver positioning algorithm, a driver profile associated with a driver of a vehicle, receiving, at the driver positioning algorithm, sensor data from a plurality of sensors within the vehicle, and determining, based on the sensor data, a conditional performance of the driver, the conditional performance corresponding to a position of the driver. The operations also include generating, via the driver positioning algorithm, a recommendation based on the determined conditional performance of the driver and monitoring, via the driver positioning algorithm, the conditional performance of the driver.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a driver position monitoring system for a vehicle.

Vehicles are often operated for extended periods, leading operators to adjust their seating positions for comfort. These adjustments, however, can create unintended blind spots or other issues that may affect vehicle operation. For instance, an operator might recline the seat or shift their position within the seat. In some cases, the natural positioning of the operator can also influence driving performance.

Many vehicles are equipped with driver monitoring systems, such as cameras or other sensor equipment, designed to detect distracted or otherwise impaired drivers. Despite their utility, these systems could be enhanced to monitor additional factors that may ultimately impact driving performance.

### SUMMARY

In some aspects, a computer-implemented method when executed by data processing hardware causes the data processing hardware to perform operations. The operations include identifying, via a driver positioning algorithm, a driver profile associated with a driver of a vehicle, receiving, at the driver positioning algorithm, sensor data from a plurality of sensors within the vehicle, and determining, based on the sensor data, a conditional performance of the driver, the conditional performance corresponding to a position of the driver. The operations also include generating, via the driver positioning algorithm, a recommendation based on the determined conditional performance of the driver and monitoring, via the driver positioning algorithm, the conditional performance of the driver.

In some examples, generating the recommendation may include issuing a prompt including a position adjustment. The operations may also include receiving, in response to the issued prompt, an input at the driver positioning algorithm and executing, via the driver positioning algorithm, a position change execution. Optionally, executing the position change execution may include automatically executing the position change execution. In some instances, the position change execution may include one or more of a seating adjustment, a steering wheel adjustment, and a lumbar adjustment. The operations may further include gathering, at a back-office server, crowd-sourced data corresponding to conditional performances of a plurality of drivers. The operations may also include communicating, via the driver positioning algorithm, the sensor data with a back-office server, the sensor data including driver position data. Optionally, determining the conditional performance includes analyzing, at the back-office server, the sensor data.

In other aspects, a driver position monitoring system including data processing hardware and memory hardware in communication with the data processing hardware. The memory hardware stores instructions that when executed on the data processing hardware cause the data processing hardware to perform operations. The operations include identifying, via a driver positioning algorithm, a driver profile associated with a driver of a vehicle, receiving, at the driver positioning algorithm, sensor data from a plurality of sensors within the vehicle, and determining, based on the sensor data, a conditional performance of the driver, the conditional performance corresponding to a position of the driver. The operations also include generating, via the driver positioning algorithm, a recommendation based on the determined conditional performance of the driver and monitoring, via the driver positioning algorithm, the conditional performance of the driver.

In some examples, generating the recommendation may include issuing a prompt including a position adjustment. The operations may also include receiving, in response to the issued prompt, an input at the driver positioning algorithm and executing, via the driver positioning algorithm, a position change execution. Optionally, executing the position change execution may include providing instructions to the driver corresponding to the position change execution. In some instances, the position change execution may include one or more of a seating adjustment, a steering wheel adjustment, and a lumbar adjustment. The operations may also include gathering, at a back-office server, crowd-sourced data corresponding to conditional performances of a plurality of drivers. The operations may further include communicating, via the driver positioning algorithm, the sensor data with a back-office server, the sensor data including driver position data. Optionally, determining the conditional performance may include analyzing, at the back-office server, the sensor data.

In further aspects, a driver position monitoring system for a vehicle includes data processing hardware and memory hardware in communication with the data processing hardware. The memory hardware stores instructions that when executed on the data processing hardware cause the data processing hardware to perform operations. The operations include identifying, via a driver positioning algorithm, a driver profile associated with a driver of a vehicle, receiving, at the driver positioning algorithm, sensor data from a plurality of sensors within the vehicle, communicating, via the driver positioning algorithm, the sensor data with a back-office server, the sensor data including driver position data, and analyzing, at the back-office server, the sensor data. The operations also include determining, based on the sensor data, a conditional performance of the driver, the conditional performance corresponding to a position of the driver, generating, via the driver positioning algorithm, a recommendation based on the determined conditional performance of the driver, and monitoring, via the driver positioning algorithm, the conditional performance of the driver.

In some examples, generating the recommendation includes issuing a prompt including a position adjustment. The operations may also include receiving, in response to the issued prompt, an input at the driver positioning algorithm and executing, via the driver positioning algorithm, a position change execution. Optionally, executing the position change execution may include providing instructions to the driver corresponding to the position change execution. The position change execution may include one or more of a seating adjustment, a steering wheel adjustment, and a lumbar adjustment.

### BRIEF DESCRIPTION OF THE DRAWINGS

The drawings described herein are for illustrative purposes only of selected configurations and are not intended to limit the scope of the present disclosure.

FIG. 1 is a schematic diagram of a vehicle equipped with a driver position monitoring system according to the present disclosure;

FIG. 2 is an example block diagram for a driver position monitoring system according to the present disclosure;

FIG. 3 is another example block diagram for a driver position monitoring system according to the present disclosure;

FIG. 4 is an exemplary flow diagram of operation of a driver position monitoring system according to the present disclosure; and

FIG. 5 is an exemplary flow diagram of a method of operation of a driver position monitoring system according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

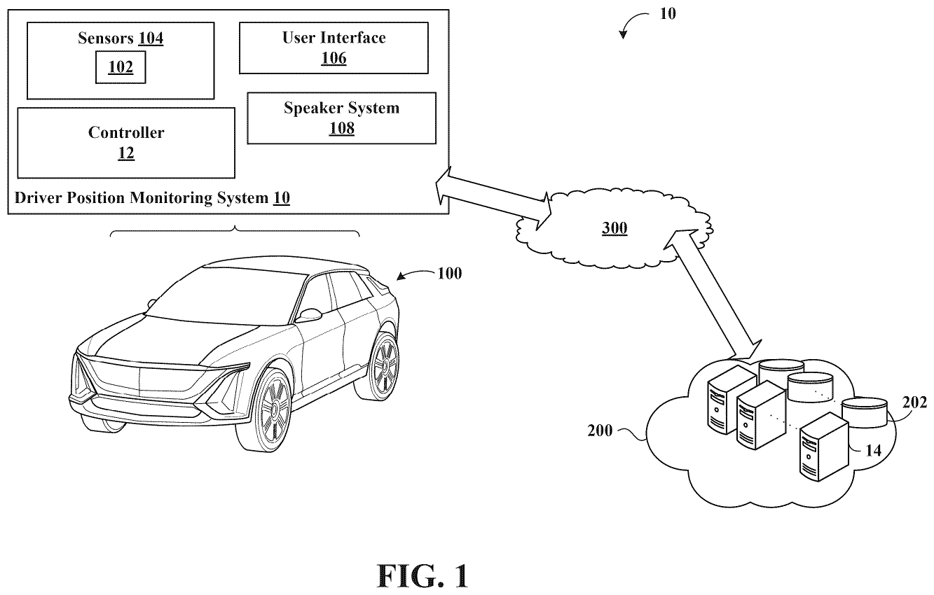

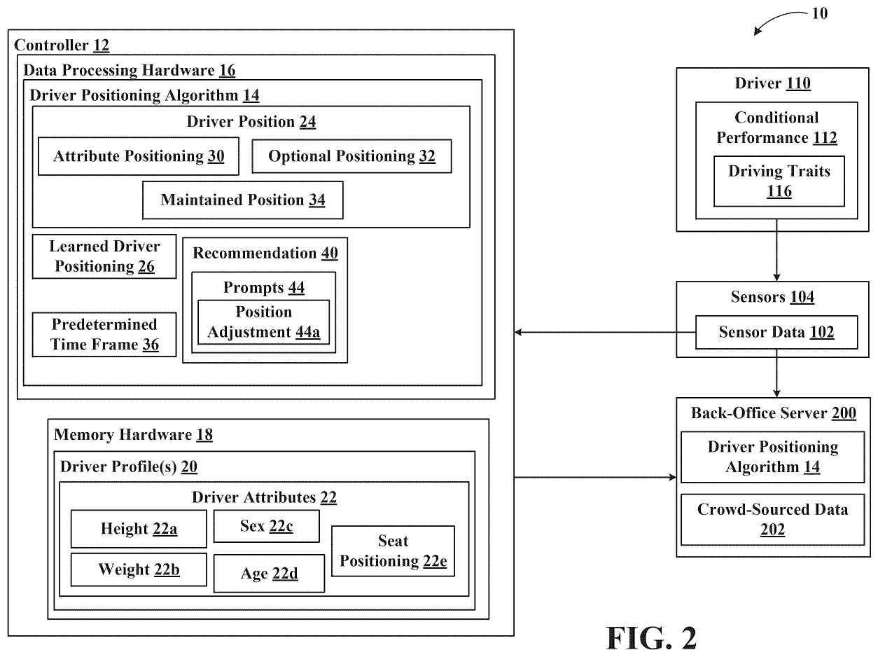

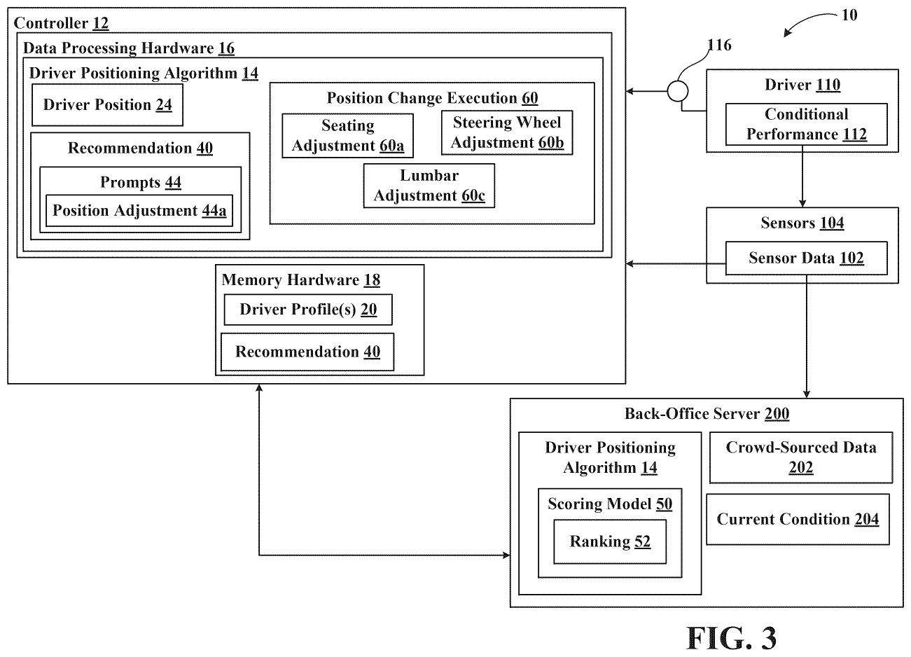

Referring to FIGS. 1-3, a driver position monitoring system 10 is configured as part of a vehicle 100 and a back-office server 200. For example, the driver position monitoring system 10 includes a controller 12 configured with a driver positioning algorithm 14 that is communicatively coupled with the back-office server 200. The controller 12 and the back-office server 200 may be communicatively coupled via a network 300. The network 300 may include any wireless communications and/or direct server communications between the controller 12 and the back-office server 200. The back-office server 200 is configured to gather crowd-sourced data 202 from a plurality of sensor data 102 from one or more vehicles 100 equipped with the driver position monitoring system 10. The crowd-sourced data 202 is utilized by the back-office server 200 during operation of the driver position monitoring system 10 to evaluate trends and/or specific driving patterns associated with the vehicle 100 based on the sensor data 102.

The sensor data 102 is captured by a plurality of sensors 104 disposed within and around the vehicle 100. The sensors 104 may include, but are not limited to, driver monitoring sensors, such as cameras, pressure sensors, lane detection sensors, blind spot monitoring sensors, LIDAR sensors, radar sensors, and other sensors utilized by various driver monitoring systems of the vehicle 100 including the driver position monitoring system 10. At least some of the sensors 104 are configured to monitor an operator or driver 110 of the vehicle 100. The sensor data 102 captured by the sensors 104 may be directly related to the driver 110 (i.e., images captured by a camera sensor 104) and/or may be indirectly related to the driver 110 (i.e., blind spot monitoring data and/or lane monitoring data). The driver position monitoring system 10 utilizes the sensor data 102 in executing the driver positioning algorithm 14 to determine a conditional performance 112 of the driver 110, described in more detail below.

With further reference to FIGS. 1-3, the driver positioning algorithm 14 is executed by data processing hardware 16 of the controller 12. The controller 12 also includes memory hardware 18 in communication with the data processing hardware 16. The memory hardware 18 stores instructions that, when executed on the data processing hardware 16, cause the data processing hardware 16 to perform operations, described herein. The memory hardware 18 may also store driver profiles 20 associated with a driver 110. The driver profiles 20 may be initially configured or set-up by the driver 110 and may include various driver attributes 22. The driver attributes 22 may include, but are not limited to, height 22a, weight 22b, sex 22c, age 22d, seat positioning 22e, among other physical characteristics that may inform a driving position 24 of the driver 110.

The driver attributes 22 may be utilized by the driver positioning algorithm 14 to establish a baseline for how the driver 110 may be positioned within the vehicle 100. For example, a driver 110 having a lesser height 22a as compared to a driver 110 having a greater height 22a may be positioned differently in the vehicle 100. Differences in driver attributes 22 may inform the driver positioning algorithm 14 when determining or otherwise identifying the conditional performance 112 associated with the driver 110. The driver profiles 20 may also be updated based on learned driver positioning 26. The learned driver positioning 26 may be periodically assessed by the driver positioning algorithm 14 based on the sensor data 102 received. The driver positioning algorithm 14 may periodically update the driver profile 20 with the learned driver positioning 26. The driver positioning algorithm 14 may also communicate the learned driver positioning 26 with the back-office server 200 as part of the crowd-sourced data 202 gathered by the back-office server 200.

The driver positioning algorithm 14 is configured to identify a driver profile 20 associated with the driver 110 of the vehicle 100 and receives the sensor data 102 from the sensors 104. In some instances, the driver positioning algorithm 14 may identify the driver profile 20 based on the last used driver profile 20, such that the driver profile 20 may be identified prior to receiving the sensor data 102. In other instances, the driver profile 20 may be identified by the driver positioning algorithm 14 upon receiving and analyzing the sensor data 102. In either configuration, the driver profile 20 is first identified prior to the driver positioning algorithm 14 assessing or otherwise determining the conditional performance 112 of the driver 110.

Referring still to FIGS. 1-3, the conditional performance 112 of the driver 110 is measured by the driver position algorithm 14 using the sensor data 102 received. The sensor data 102, as mentioned above, may correspond to blind spot sensors, automatic braking, cross-zone sensors, and other driver monitoring sensors 104. The driver position algorithm 14 may determine that one or more of the sensors 102 is being triggered while also analyzing sensor data 102 from an in-cabin camera 104. The driver position algorithm 14 may determine that the conditional performance 110 is associated with a position, posture, or other environmental factor resulting from the selected seating angle of the driver 110 that may impact the operability of the vehicle 100.

For example, the conditional performance 112 may be an inherent positioning of the driver 110 within the vehicle 100 and/or may be an optional seating preference or position selection made by the driver 110 during operation of the vehicle 100. The driver positioning algorithm 14 may be configured to differentiate between driver positions 24. The driver position 24 may include attribute positioning 30 and optional positioning 32 based on the driver profile 20 and sensor data 102. The attribute positioning 30 is generally associated with the driver attributes 22 that are physically associated with the driver 110, such that the driver 110 cannot opt-out of the positioning due to the driver attributes 22. The optional positioning 32 is generally associated with a selected or chosen position in which the driver 110 has voluntarily positioned themselves.

In some instances, the conditional performance 112 may be associated with the driver 110 remaining in a position for an extended period of time. For example, the driver 110 may become fatigued as a result of a position of the driver 110 remaining unchanged. The driver 110 becoming fatigued as a result of the unchanged position is distinct from the driver 110 becoming fatigued as a result of drowsiness or other physiological factors. The fatigue associated with the conditional performance 112 is a result of prolonged duration in a particular position rather than physiological factors of drowsiness. For example, the driver positioning algorithm 14 may be configured to detect a maintained position 34 over a predetermined time frame 36 based on the sensor data 102.

The driver positioning algorithm 14 is configured to determine the conditional performance 112 and present the driver 110 with a recommendation 40. The recommendation 40 is based on the conditional performance 112 determined by the driver positioning algorithm 14 and is configured to provide assistance to the driver 110 to reposition in a manner that improves operation performance by the driver 110 of the vehicle 100. The driver positioning algorithm 14 continuously monitors the sensor data 102 provided by the sensors 104 to determine the conditional performance 112. In some instances, the driver 110 may operate the vehicle 100 free of conditional performances 112 and a later time point change positions in a manner that results in detection and determination of the conditional performance 112.

With further reference to FIGS. 1-3, the driver positioning algorithm 14 may be executed on the controller 12 of the vehicle 100, while the processing of the driver positioning algorithm 14 may occur at the back-office server 200. The sensor data 102 is continuously uploaded to the back-office server 200 for analysis by the back-office server 200. The back-office server 200 may also receive sensor data 102 from other vehicles 100 equipped with the driver position monitoring system 10, such that the back-office server 200 may utilize crowd-sourcing to identify various conditional performances 112 of drivers 110 in operation.

The driver positioning algorithm 14 is configured to measure the conditional performance 112 using a variety of driving traits 114 detected by sensors 104 in combination with the gathered sensor data 102. The driving traits 114 may include, but are not limited to, braking techniques, cornering techniques, aggressive lane-change, disregarding blind spots, and other traits that may influence driver performance. The driver positioning algorithm 14 analyzes, at the back-office server 200, the sensor data 102 in order to generate the recommendation 40 based on the conditional performance 112.

The conditional performance 112 may be a result of the position of the driver 110 in the vehicle 100. For example, the driver 110 may centrally lean on a center console of the vehicle 100 to rest or reposition while operating the vehicle 100. The sensors 104 may detect the shift in position of the driver 110, which is communicated to the driver positioning algorithm 14 as sensor data 102. In other examples, the driver 110 may be seated at a distance from a steering wheel of the vehicle 100, such that a view of the driver 110 may be impeded by the position of the driver 110. In response, the back-office server 200 and/or the controller 12 analyzes the sensor data 102, and the driver positioning algorithm 14 generates the recommendation 40.

The recommendation 40 may include various prompts 44 to assist the driver 110 in repositioning to minimize the conditional performance 112. For example, the driver positioning algorithm 14 may issue a prompt 44 including a position adjustment 44a. The position adjustment 44a is configured to reduce the conditional performance 112 by providing a revised position to the driver 110. The driver positioning algorithm 14 awaits an input 116 from the driver 110 before proceeding with executing the position adjustment 44a. In some instances, the driver 110 may dismiss the prompt 44. In other instances, the driver positioning algorithm 14 may wait to issue the prompt 44 until the vehicle 100 is stationary or otherwise in a state that movement of the position of the driver 110 is safe.

The driver positioning algorithm 14 may also be configured with a scoring model 50 to correlate different conditional performances 112. The scoring model 50 is executed by the back-office server 200 and used to compare the conditional performances 112 across vehicles 100 equipped with the driver position monitoring system 10. The back-office server 200 may utilize the scoring model 50 to identify unique differences between various vehicles 100 (i.e., makes and models) that may present as limitations as a result of the seating. The scoring model 50 may be configured as a weighted algorithm that assigns a ranking 52 to the driver position 24. The ranking 52 may also be configured with weighting to differentiate the driver position 24 within the driver positioning algorithm 14.

For example, the driver positioning algorithm 14, via the back-office server 200, may analyze how close to the middle the driver 110 is positioned, how far from a steering wheel, how far feet of the driver 110 are from pedals, etc. The back-office server 200 utilizes the scoring model 50 to evaluate the different driver profiles 20 that are presented and assess the number and severity (i.e., ranking 52) of the various conditional performances 112. The back-office server 200 communicates the ranking 52 of the conditional performance 112 via the driver positioning algorithm 14, and the driver positioning algorithm 14 executes the recommendation 40 based on the ranking 52.

If the ranking 52 indicates that the driver position 24 is unsafe or otherwise resulting in conditional performances 112 that may be unsafe, then the driver positioning algorithm 14 may execute the recommendation 40 after generating the recommendation 40 to the driver 110. If the ranking 52 is low or otherwise indicating that the driver position 24 could be improved but is safe, then the driver positioning algorithm 14 may generate the prompt 42 and wait to receive an input 116 from the driver 110. In response to the input 116, the driver positioning algorithm 14 executes a position change execution 60. The position change execution 60 includes executing one or more of the position adjustments 44a. For example, the position change execution 60 may include one or more of a seating adjustment 60a, a steering wheel adjustment 60b, and a lumbar adjustment 60c.

The driver positioning algorithm 14 may provide instructions to the driver 110 corresponding to the position change execution 60. For example, the driver positioning algorithm 14 may provide the instructions on a user interface 106 of the vehicle 100 and/or may provide the instructions via audio through a speaker system 108 of the vehicle 100. In other instances, the driver positioning algorithm 14 may automatically deploy the position change execution 60 in response to the input 116. If the driver 110 rejects the recommendation 40, then the driver positioning algorithm 14 may store the recommendation 40 in the memory hardware 18 for future use. Even after the driver positioning algorithm 14 executes the position change execution 60, in response to the input 116, the driver positioning algorithm 14 continues to monitor the sensor data 102, and the back-office server 200 continues to execute the scoring model 50 to determine whether the position change execution 60 resulted in a positive change of operation of the vehicle 100. The back-office server 200 utilizes the updated sensor data 102 to improve the scoring model 50, such that the scoring model 50 may effectively learn from the sensor data 102 and adjustments made by the driver positioning algorithm 14.

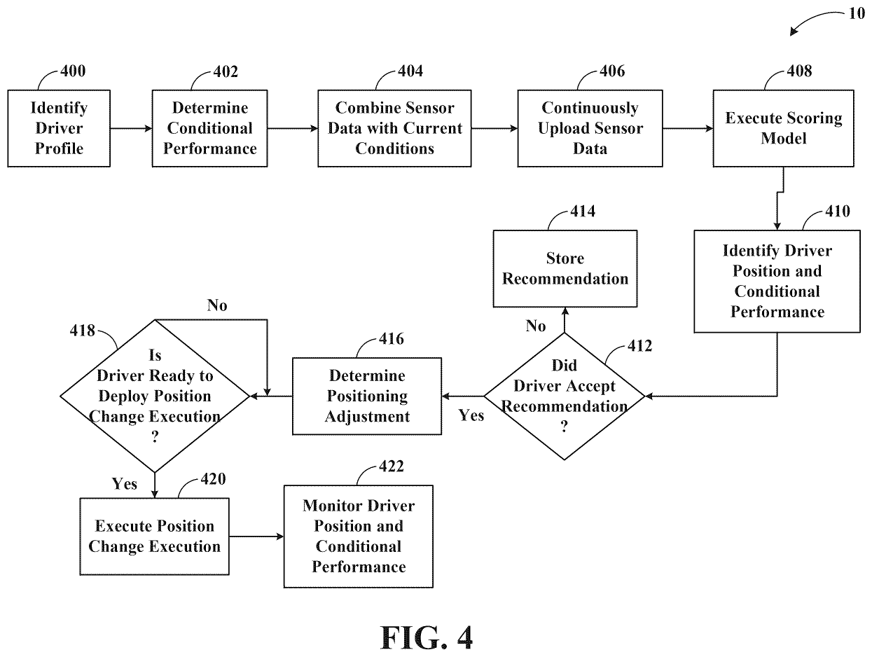

Referring to FIG. 4, an exemplary flow diagram of operation of the driver position monitoring system 10 is illustrated. At 400, the driver positioning algorithm 14 identifies a driver 110 with a known driver profile 20 as operating the vehicle 100. The driver positioning algorithm 14 determines, at 402, conditional performance 112. The sensor data 102 is combined, at 404, by the back-office server 200 with current conditions 204. The current conditions 204 may include, but are not limited to, time of day, vehicle type, location type, and total driving time. The driver positioning algorithm 14 continuously uploads, at 406, the sensor data 102 to the back-office server 200. At 408, the back-office server 200 executes the scoring model 50 to correlate different conditional performances 112. The correlation of the different conditional performances 112 may be utilized by the driver position monitoring system 10 to identify blind spots and other physical limitations associated with the driver position 24.

At 410, the driver positioning algorithm 14 identifies the driver position 24 and the associated conditional performance 112. The driver positioning algorithm 14 determines, at 412, whether the driver 110 has accepted the recommendation 40. If the driver 110 does not accept the recommendation 40, then the driver positioning algorithm 14 may store the recommendation 40, at 414. If the driver 110 accepts the recommendation 40, then the driver positioning algorithm 14 determines, at 416, the positioning adjustment 44a. The driver positioning algorithm 14 may prompt the driver 110 again to determine, at 418, whether the driver 110 is ready to deploy the position change execution 60. If not, then the driver positioning algorithm 14 will wait for the input 116 from the driver 110. If the input 116 is received, then the driver positioning algorithm 14 executes, at 420, the position change execution 60. The driver positioning algorithm 14 continues to monitor, at 422, the driver position 24 and any potential resultant conditional performance 112.

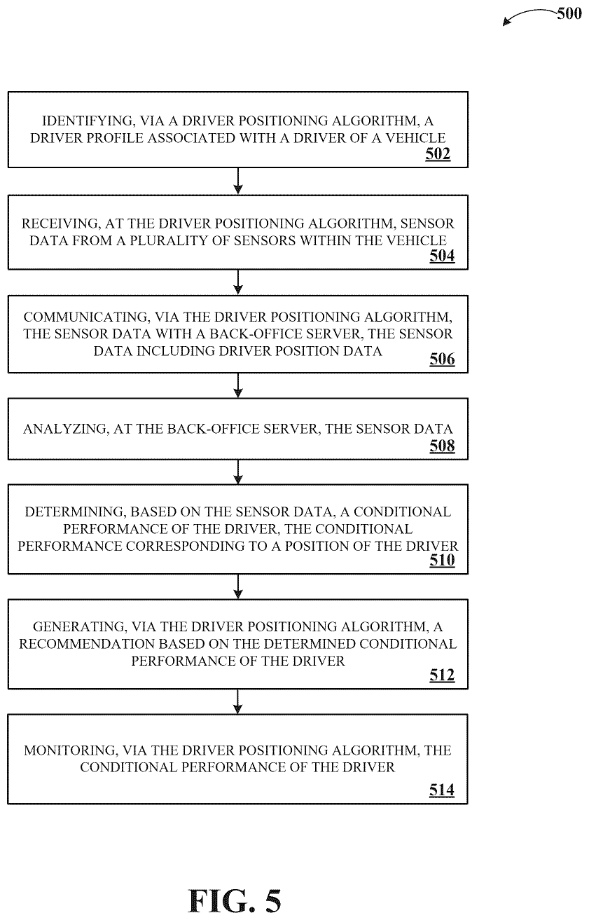

With reference now to FIG. 5, a method 500 of operation of the driver position monitoring system 10 is illustrated. At 502, a driver positioning algorithm 14 identifies a driver profile 20 associated with a driver 110 of a vehicle 100 and receives, at 504, sensor data 102 from a plurality of sensors 104 within the vehicle 100. The driver positioning algorithm 14 communicates, at 506, the sensor data 102 with a back-office server 200. The sensor data 102 includes driver position data 102a. The back-office server 200 analyzes, at 508, the sensor data 102 and determines, at 510, based on the sensor data 102, a conditional performance 112 of the driver 110. The conditional performance 112 corresponds to a position of the driver 110. At 512, the driver positioning algorithm 14 generates a recommendation 40 based on the determined conditional performance 112 of the driver 110. The driver positioning algorithm 14 monitors, at 514, the conditional performance 112 of the driver 110.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed by data processing hardware causes the data processing hardware to perform operations comprising:
identifying, via a driver positioning algorithm, a driver profile associated with a driver of a vehicle;
receiving, at the driver positioning algorithm, sensor data from a plurality of sensors within the vehicle;
determining, based on the sensor data, a conditional performance of the driver, the conditional performance being fatigue of the driver corresponding to a maintained position of the driver for an extended period of time;
generating, via the driver positioning algorithm, a recommendation based on the determined conditional performance of the driver;
receiving, in response to the recommendation, an input from the driver;
executing, in response to the input, a position change execution, the position change execution including one or more of a seating adjustment, a steering wheel adjustment, and a lumbar adjustment; and
monitoring, via the driver positioning algorithm, the conditional performance of the driver.

2. The method of claim 1, wherein generating the recommendation includes issuing a prompt including a position adjustment.

3. (canceled)

4. The method of claim 1, wherein executing the position change execution includes automatically executing the position change execution.

5. (canceled)

6. The method of claim 1, further including gathering, at a back-office server, crowd-sourced data corresponding to conditional performances of a plurality of drivers.

7. The method of claim 1, further including communicating, via the driver positioning algorithm, the sensor data with a back-office server, the sensor data including driver position data.

8. The method of claim 7, wherein determining the conditional performance includes analyzing, at the back-office server, the sensor data.

9. A driver position monitoring system comprising:
data processing hardware; and
memory hardware in communication with the data processing hardware, the memory hardware storing instructions that when executed on the data processing hardware cause the data processing hardware to perform operations comprising:
identifying, via a driver positioning algorithm, a driver profile associated with a driver of a vehicle;
receiving, at the driver positioning algorithm, sensor data from a plurality of sensors within the vehicle;
determining, based on the sensor data, a conditional performance of the driver, the conditional performance being fatigue of the driver corresponding to a maintained position of the driver for an extended period of time;
generating, via the driver positioning algorithm, a recommendation based on the determined conditional performance of the driver;
receiving, in response to the recommendation, an input from the driver;
executing, in response to the input, a position change execution, the position change execution including one or more of a seating adjustment, a steering wheel adjustment, and a lumbar adjustment; and
monitoring, via the driver positioning algorithm, the conditional performance of the driver.

10. The driver position monitoring system of claim 9, wherein generating the recommendation includes issuing a prompt including a position adjustment.

11. (canceled)

12. The driver position monitoring system of claim 9, wherein executing the position change execution includes providing instructions to the driver corresponding to the position change execution.

13. (canceled)

14. The driver position monitoring system of claim 9, further including gathering, at a back-office server, crowd-sourced data corresponding to conditional performances of a plurality of drivers.

15. The driver position monitoring system of claim 9, further including communicating, via the driver positioning algorithm, the sensor data with a back-office server, the sensor data including driver position data.

16. The driver position monitoring system of claim 15, wherein determining the conditional performance includes analyzing, at the back-office server, the sensor data.

17. A driver position monitoring system for a vehicle, the driver position monitoring system comprising:
data processing hardware; and
memory hardware in communication with the data processing hardware, the memory hardware storing instructions that when executed on the data processing hardware cause the data processing hardware to perform operations comprising:
identifying, via a driver positioning algorithm, a driver profile associated with a driver of a vehicle;
receiving, at the driver positioning algorithm, sensor data from a plurality of sensors within the vehicle;
communicating, via the driver positioning algorithm, the sensor data with a back-office server, the sensor data including driver position data;
analyzing, at the back-office server, the sensor data;
determining, based on the sensor data, a conditional performance of the driver, the conditional performance being fatigue of the driver corresponding to a maintained position of the driver for an extended period of time;
generating, via the driver positioning algorithm, a recommendation based on the determined conditional performance of the driver;
receiving, in response to the recommendation, an input from the driver;
executing, in response to the input, a position change execution, the position change execution including one or more of a seating adjustment, a steering wheel adjustment, and a lumbar adjustment; and
monitoring, via the driver positioning algorithm, the conditional performance of the driver.

18. The driver position monitoring system of claim 17, wherein generating the recommendation includes issuing a prompt including a position adjustment.

19. (canceled)

20. The driver position monitoring system of claim 17, wherein executing the position change execution includes providing instructions to the driver corresponding to the position change execution.

21. The method of claim 6, further comprising:
executing, via the back-office server, a scoring model of the driver positioning algorithm; and
comparing, via the back-office server, each of the conditional performances of the crowd-sourced data, the crowd-sourced data corresponding to a plurality of vehicles equipped with a driver position monitoring system.

22. The method of claim 21, further comprising:
identifying, via the scoring model, differences between a make and model of each of the plurality of vehicles; and
determining limitations as a result of seating based on the make and model of each of the plurality of vehicles.

23. The driver position monitoring system of claim 14, further comprising:
executing, via the back-office server, a scoring model of the driver positioning algorithm; and
comparing, via the back-office server, each of the conditional performances of the crowd-sourced data, the crowd-sourced data corresponding to a plurality of vehicles equipped with a driver position monitoring system.

24. The driver position monitoring system of claim 23, further comprising:
identifying, via the scoring model, differences between a make and model of each of the plurality of vehicles; and
determining limitations as a result of seating based on the make and model of each of the plurality of vehicles.

25. The driver position monitoring system of claim 17, further comprising:
gathering, at the back-office server, crowd-sourced data corresponding to conditional performances of a plurality of drivers;
executing, via the back-office server, a scoring model of the driver positioning algorithm; and
comparing, via the back-office server, each of the conditional performances of the crowd-sourced data, the crowd-sourced data corresponding to a plurality of vehicles equipped with a driver position monitoring system.
